(19) United States
(12) Patent Application Publication
(10) Pub. No.: US 2008/0149665 A1
(43) Pub. Date: Jun. 26, 2008

(54) Vapor-dispersing device with pressure-responsive valve

(75) Inventors: Kevin Hafer, Scottsdale, AZ (US); John Billman, Scottsdale, AZ (US)

Correspondence Address: THE DIAL CORPORATION, 15501 N. DIAL BOULEVARD, SCOTTSDALE, AZ, 85260, US

(73) Assignee: The Dial Corporation

(21) Appl. No.: 11/643,080

(22) Filed: Dec. 21, 2006

(51) Int. Cl. B05B 12/10; B05B 17/00; B05B 1/24; B65D 65/04

(52) U.S. Cl. 222/3; 239/136; 239/128; 206/497; 222/54

(57) ABSTRACT

A vapor-dispersing device is described that comprises a pressurizable vessel with at least one opening equipped with a pressure-responsive valve that controllably releases vapor in bursts when the vessel is heated through a controlled heating means.

### FIELD OF INVENTION

The present invention relates to vapor-dispersing devices and in particular to a vapor-dispersing device comprising a pressurizable vessel equipped with a pressure-responsive valve, whereby the device repeatedly bursts warm vapor into the surrounding environment when the vessel is heated. The device of the present invention will find use as an air freshener for dispersing fragrance vapors, an insecticide/animal deterrent device for delivery of insecticidal or animal repellant vapors, a medicament vaporizer and as a humidifier.

### BACKGROUND

Vapor-dispersing devices are well known and include a variety of devices for vaporizing liquid, gel or waxy materials such as fragrance oils or insecticides into the surrounding environment, or for vaporizing camphor, eucalyptus and other medicaments. For example, vapor-dispersing devices include electrical devices with resistive heater elements and/or fans for driving liquids, oils or solids into the vapor phase, passive devices that rely on large surface area emanating pads or wicks and air flow that require no energy input to evaporate liquids, and simple aerosol spray cans that propel and disperse liquids into fine droplets that evaporate in the air, such as the Renuzit® Subtle Effects™ aerosol sprays. Vapor-dispersing devices that are electrically powered are very common in homes and in institutional settings around the world. Simple vaporizers involve the heating of water to produce steam that moves over a medicament cup, and the warm stream of steam heats and volatilizes the medicament into the surrounding area. Other vapor-dispersing devices include air fresheners and insecticide devices. These devices may be comprised of a bottle of volatile liquid and they may operate by heat to volatize the liquid. Most common of these devices are air fresheners wherein a porous plastic wick is in communication with a bottle of scented fragrance oil and where that wick, continuously saturated with the fragrance, is placed in close proximity to a resistive heater element that accelerates the evaporation of the liquid from the wick. Such a bottle, fragrance oil and wick combination is seen in the Renuzit® Scented Oil Electric Refills. Another common configuration for a household air freshener is where a bottle of scented fragrance oil contains a porous plastic wick and the wick is positioned in front of a fan. In these devices the fan moves air across the wick and the scented air is expelled into the immediate environment. These devices exist in the marketplace, both house current (110 v/220 v, AC) powered and battery powered (1.5 v, 3 v, 9 v, etc., DC). Such a device includes the Mobil' Air® Portable Electric Diffuser air freshener from Reckitt Benckiser. More elaborate devices include piezoelectric assemblies wherein the scented fragrance oil is wicked up from a reservoir onto a vibrating plate where it is expelled into very fine droplets that quickly evaporate. Interestingly enough, what is entirely absent in the field of vapor-dispersing devices such as air fresheners, insecticide devices and medicament vaporizers is a simple delivery device that uses a heated pressurizable vessel to produce warm vapor.

An air freshener having squeezable bellows to produce scented vapor through a valve was claimed by Donald Spector (U.S. Pat. No. 6,520,826). Devices that employ a bellows-type action to expel scented air include the devices described in U.S. Pat. No. 4,869,407 to Booth, et al. Additionally, U.S. Pat. No. 7,059,544 issued to Leonard describes a speaker (like a loudspeaker) that creates air movement in the form of air pulses that blast over a bottle of fragrance having an exposed wick. The devices described by Spector, Booth and Leonard respectively are not heated, although the loudspeaker devices described by Leonard are electronically controlled. Also known from an unrelated field is a smoke generator that relies on the heating of a pressurizable container to liberate smoke (U.S. Pat. No. 6,481,344 issued to Green). However, the valve on the pot in that invention is only a safety pressure-relief valve and is not intentionally the outlet port from where the smoke is dispensed.

We have invented a unique way to dispense vapor by placing volatile compositions into a pressurizable container equipped with a pressure-responsive valve and to heat/cool said vessel in a very controlled manner such that the device bursts heated vapor through the valve. The heating and cooling of a pressurizable vessel that contains a volatizable composition is a convenient way to deliver controlled bursts of warm vapor to the surrounding environment provided that the vessel is equipped with a valve that responds (i.e., opens and re-closes) to changes in the internal pressure of the vessel. The advantage of such a design is that the vessel itself, containing the volatile composition and fitted with the pressure-responsive valve, may be merchandised as the disposable refill for the device so that the consumer can easily change out vessels and never contact the volatile composition.

### SUMMARY OF THE INVENTION

It has now been discovered that controlled delivery of vapor into the surroundings can be achieved by regulating bursts of heated vapor from a pressurizable container equipped with a pressure-responsive valve. Additionally, and depending on the vaporizable composition within the vessel, the device may also impart humidity or other benefits to the air surrounding the vessel. Most useful is that the sealed pressurizable vessel may be marketed as a disposable refill for use in this electronic vapor-dispersing device.

For example, the present invention relates to a device that minimally comprises a pressurizable vessel containing a volatile composition and fitted with a pressure-responsive valve, a heating means to heat the vessel and a control means to regulate the heating of the vessel. When the vessel is heated, internal pressure develops from the heated volatile composition (i.e., its vapor pressure is increased) and the pressure-responsive valve opens momentarily to release the built-up internal pressure by way of a burst of warmed vapor. The valve re-closes after the pressure has been vented and has dropped below a lower threshold value. If the container is cooled, (either through ambient or controlled cooling), external air may be pulled back into the vessel through either the same valve or through a separate valve, equilibrating the pressure between the inside and outside of the vessel and placing the device into a standby/off state. The control means may be programmable such that the delivery rate of the vapor bursts from the device is controlled by the regulation of heating cycles to the pressurizable vessel. The cooling of the pressurizable vessel of the present invention may be ambient or may also be electronically controlled. The important feature of the present invention is that the valve is pressure-responsive and operates (opens/closes) within a predetermined pressure range. That is, the valve will open when an upper threshold pressure is reached in the vessel and will re-close after the burst of vapor is released, since the internal pressure will be less than that needed to hold the valve open once the pressure is vented. Control over the vapor bursts is through maintenance of the temperature of the vessel so that the internal pressure of the vessel can be held just around this lower end of the range of pressures at which the valve operates. A preferred embodiment is to maintain the vessel in a “warm” state and to electrically regulate additional heating boosts of the vessel to spike the internal vapor pressure repeatedly over the threshold pressure required to open the valve. Maintaining the vessel at a warmed temperature reduces the time required to heat the vessel up to the temperature necessary to build-up the threshold pressure enough to open the valve.

### BRIEF DESCRIPTION OF THE DRAWINGS

FIG. 1 conceptually illustrates the basic configuration of the vapor-dispersing device of the present invention comprising a pressurizable vessel with pressure-responsive valve in a housing with heating means and electrical control means.

FIG. 2 illustrates one embodiment of the opening of the pressurizable vessel of the present invention wherein a pressure-responsive valve is held in the opening with a threaded fastening ring.

FIGS. 3a, 3b, and 3c illustrate a preferred embodiment of an elastomeric pressure-responsive valve for use in the device of the present invention.

FIG. 4 illustrates one preferred embodiment of the pressure-responsive valve of the present invention while venting warmed vapors under pressure.

FIG. 5 conceptually illustrates another embodiment of the vapor-dispersing device of the present invention further comprising a cooling means.

FIG. 6 illustrates one preferred embodiment of the device of the present invention comprising a sealed and disposable refill containing a volatizable composition, which fits into one embodiment of the housing.

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function, the size, and arrangement of the elements described without departing from the scope of the invention as set forth in the appended claims. Most importantly, changes in shape and size of the overall device or changes to the specifications and mechanics of the valve or the other elements do not depart from the intended scope of the invention. Although the present invention is described in utilitarian terms as an air freshener, insecticide vapor disperser, medicament vaporizer and humidifier, other useful applications for controlled warm-vapor dispensing may be envisioned and fall within the scope of the present invention.

That said, the present invention relates to a vapor-dispersing device comprising a pressurizable container fitted with a pressure-responsive valve that shows a more reliable evaporation of volatiles than conventional electrical devices that utilize resistive heating of wicks placed inside unheated containers of liquids. The device of the present invention may find utility as an air freshener to disperse fragrance vapors, as an insecticide device to disperse insecticidal vapors and as a medicament vaporizer for personal or professional medical use.

The present invention relates to a device that minimally comprises, (a) a housing, (b) a pressurizable, substantially rigid and non-deformable, heat resistant vessel with at least one opening equipped with at least one pressure-responsive valve; (c) a volatizable composition sealed within the vessel; (d) a heating means within the housing to heat the vessel when inserted in the housing; and (e) an electrical control means for controlling the heating means and thus controlling the heating of the vessel. Optionally, the present invention may include a controlled cooling means such as a motor and fan and that may be controlled from the same electrical control means as the heating means. The volatizable composition of the present invention is meant to include any pure synthetic or natural material or any synthetic or natural mixture of components that include at least one volatizable substance. The volatizable composition within the vessel may comprise any physical form, (e.g. thin liquid solution, thick liquid mixture, oil, emulsions, suspensions, solids, waxes, semi-solids, gels, beads, coated granules, leaves, herbs, berries, fruits, sticks, etc.), and may consist of a pure single chemical entity or a mixture of chemicals, (actives and solvents) in a composition, so long as at least one substance contained in the materials of the composition is volatizable and can develop a measurable vapor pressure when heated above ambient temperature such that the internal pressure developed within the vessel is substantial enough to momentarily open the vapor-responsive valve. The device may stay in a constantly warmed state and only oscillate within a short temperature range to generate the range of internal pressures that a particular valve responds to.

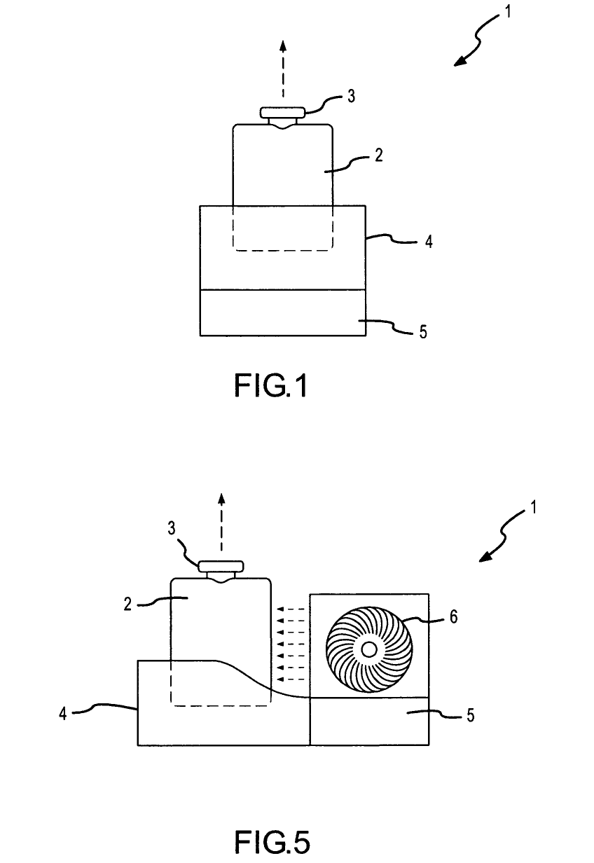

Referring now to FIG. 1, the size of the overall device 1 of the present invention may be any size practical to maintain function, and the conceptual diagram of FIG. 1 is not intended to connote any particular physical size. It may be miniaturized, just a few inches in height and width, or the device may be quite large, perhaps as large as 24 inches or more in height and in width. It may be personal, portable or permanently installed. A smaller dimensioned device may be used to treat a small room with volatized material such as an insecticide or fragrance, whereas a large unit may be used in institutional and industrial settings to disperse large amounts of vaporized material such as perfumes or insecticides into much larger spaces including outdoor areas. A version of the device 1 may find use as a personal vaporizer for medicament dispensing. The device 1 may sit on a surface, such as a floor, table or a shelf in a home or industry, or it may be mounted to a wall or to a ceiling or plugged directly into an electrical outlet for support. It may be held in the hand and carried or connected to a delivery tube that directs warm vapors towards the nasal passages. It may be placed out of sight, for example inside of HVAC air ductwork, or it may be placed outdoors. It may be decorative and displayable or it may be utilitarian in appearance and hidden from view when in use. It may be commercially used when tenting a house to eradicate infestations or may be subtler as a tabletop mosquito repellant dispenser for a patio area. The examples thus given are not intended to be limiting but are instead listed to give a taste of the useful scope of the present invention.

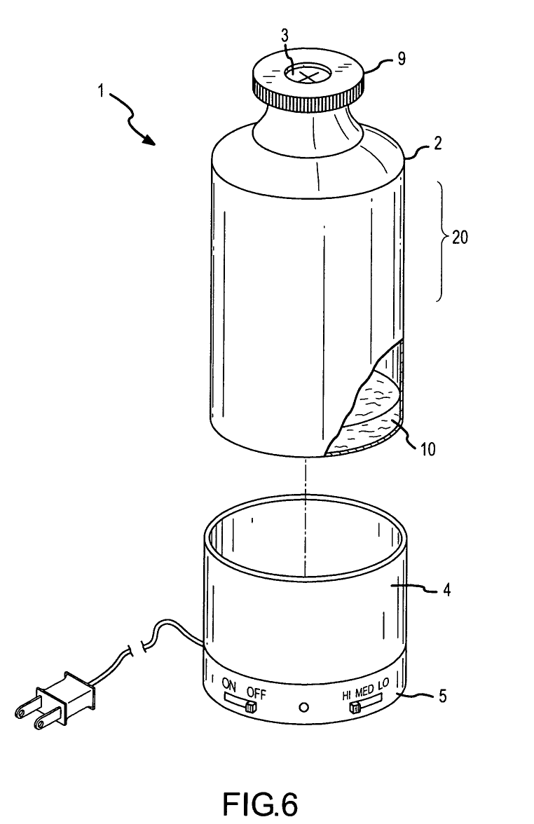

Now referring to the individual components depicted in FIG. 1, the device 1 minimally comprises a pressurizable vessel 2 with at least one opening fitted with a vapor-responsive valve 3, a housing 4 for reversibly accepting the vessel and for supporting the heating means, and an electrical control means 5 to control the said heating means. Not shown in FIG. 1, but certainly essential to the device of the present invention, is a volatizable composition sealed within said vessel (described below). The device 1 generally depicted in FIG. 1 operates by controlled heating of the sealed vessel 2 to create very defined internal pressure increases that momentarily open the valve 3 to release warmed bursts of vapor from the volatizable composition. The housing 4 is intended to contain and support the vessel, the heating means and the optional cooling means of the present invention. The housing may also encompass and be integral with the electrical control means, or the electrical control means may comprise it's own separate housing and the two housings may come together in a more modular configuration (e.g. as described later in reference to FIG. 6). The housing may comprise decorative elements or may be only structural and functional, and it may be any shape or size convenient for the purpose of the device, (round, square, etc.). The housing defines a recessed area for accepting the vessel of the present invention, and the heating means is supported within the housing such that the heating elements within the heating means come into close proximity to the vessel when the vessel is inserted into the recess of the housing. The housing 4 may be comprised of plastic, metal, glass, fiberboard, or a combination of these materials. The recessed area of the housing may be deep enough to fully engulf the vessel when it is inserted within, or it may be shallower than the height of the vessel such that the vessel may protrude out from the housing even when inserted into the housing. The housing may further comprise a lid, and that lid may be hinged or otherwise fastened to the remainder of the housing. Such an optional lid may find use in the present invention, for example to help with consumer safety, to add decoration, to help hold the vessel down into the recess and aid in contact with the heating means of the present invention, to help (through a vent, channel or chimney, for example) the direction of the warm vapor bursts. In these examples, the housing with optional lid may take on many functional configurations, shapes, sizes and decorative designs. Essential to the present invention is the reversible engagement of the vessel with the recess defined by the housing. For purposes of supplying a fresh vessel of volatizable composition, it is desirable for the vessel to be fully removable from the housing for the purposes of replacing or refilling. Such a refillable configuration allows the user to maintain the same electronic components of the device (housing, heating means, electrical control means) and merely dispose or refill the vessel by removing it from the remainder of the device. The vessel 2 may simply drop into the recess of the housing 4, or it may snap or more securely fasten within, however it is preferred that the vessel come into a heat-transfer relationship with the heating means when it is inserted within the recess of the housing, (i.e., the vessel should come into close proximity or even touch the heating means when inserted into the recess of the housing).

The vessel 2 may be constructed of any number of materials and may be one piece or several pieces fitted together. Vessel 2 must be substantially rigid so that it does not physically expand to any appreciable degree or rupture or melt when heated, it must have some degree of heat transfer ability from exterior surface to interior contents, and it must also comprise at least one opening. For example, preferred materials for the vessel include but are not limited to polyvinylchloride (PVC), polypropylene (PP), polyethylene (PE), polyvinylacetate (PVA), polyethyleneterephthalate (PET), and of course, glass or metal. Any one of these materials allows for one-piece construction of the vessel, for example by injection blow-molding of plastic, molding of glass bottles in suitable molds, or stamping or extruding one-piece metal vessels from a metal puck. Depending on the overall shape of the vessel 2, the construction may be two-pieces or more, and the individual parts may be welded together, glued together or melted together (sonic welded for example). For example, a pressurizable vessel for use in the present invention may comprise a steel can or a combination of steel and aluminum, constructed from three pieces, a rolled sidewall, a base and a top, all crimped and/or welded together. The shape of the vessel 2 for the present invention is not critical, although a cylindrically shaped vessel is preferred, especially for the metal construction options. It is preferable to have small vessels that are either injection blow-molded from suitable plastics or are aluminum or steel in construction. For example, of particular use in the present invention is a one-piece aluminum cylinder with a flat bottom resembling an aluminum aerosol can, since such a vessel is corrosion resistant and rigid and has exceptional heat transfer ability. The internal capacity of the vessel is preferably from about 5 mL to about 5 L. Most preferred is to utilize a one-piece aluminum vessel having internal capacity of from about 10 mL to about 100 mL and to shape the vessel without shoulders and with the top of the vessel culminating in a small flanged circular opening of from about 0.5 cm to about 2.0 cm in diameter to accept and seat the valve, all very much like in the aerosol industry. As mentioned, the vessel 2 comprises at least one opening and one of these openings may be equipped with a pressure-responsive valve that will be described below. To ensure sealing of the valve into the opening, it is preferable to have a flange or lip around the opening of the vessel that may act as a valve seat for the valve (described below). Other openings on the vessel are optional and these may be fitted with other valves or closures (permanent or removable), or simply sealed (e.g. burned/melted/welded) closed after a filling operation. For example, one such additional and optional opening in the vessel 2 may be used as an inlet for the manufacturer to fill the vessel with the volatizable composition, or perhaps for the end user to refill the vessel if a refillable rather than disposable version of the vessel is marketed for use in the present invention.

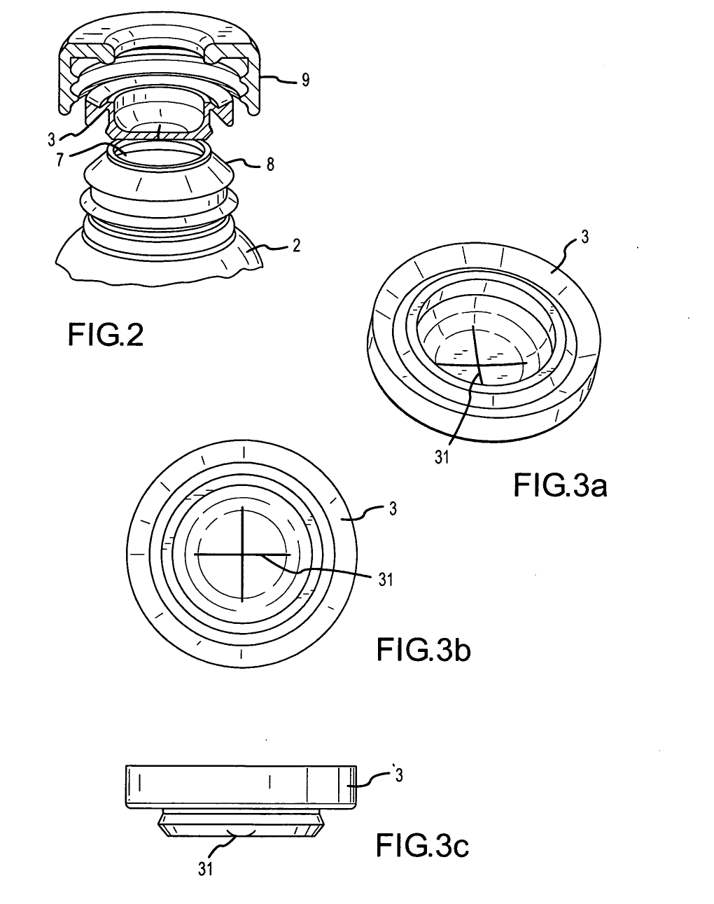

One of the essential components to the device 1 of the present invention is the pressure-responsive valve 3 fitted into the opening of the vessel 2, as introduced in FIG. 1 and detailed now in FIGS. 2 and 3a,b, and c. The valve 3 is the outlet for the warmed vapors and momentarily opens when the internal pressure of the vessel 2 comes within a certain fixed pressure range from heating the vessel and its contents. Many valves available in the market are pressure-responsive. These include, but are not limited to slit, duckbill, and umbrella type valves, any one of which either retain their basic shape when venting through one or more slits, or that “roll out” and invert as they vent (i.e., turn completely inside out). Preferred valves include elastomeric valves, a type of valve that is made from elastomeric polymer so that the valve returns to its molded shape after venting, (i.e., the polymeric valve has shape memory). Some of these polymeric valves are used to dispense liquids such as bodywash or shampoo from inverted plastic squeeze bottles, wherein squeezing the bottle forces the liquid or gel out through slits that open outwards under the pressure. Most preferred for use in the present invention is a one-way or bidirectional one-piece elastomeric valve, such as the LMS MediFlow™, LMS SureShot™ and LMS SureFlow™ valves available from Liquid Molding Systems, Inc of Midland, Mich., which are described in U.S. Pat. Nos. 5,213,236, 5,377,877, 5,339,995, and 5,409,144 and incorporated herein. These preferred valves comprise one-piece elastomeric silicone that respond to predetermined pressures, rolling out and inverting as the gasses are vented out of opened slits. The thickness of the polymer and the diameter of the valve along with the slit configuration determine the pressure ranges at which the valve opens up. The most preferred valve for use in the present invention is the LMS MediFlow™ available from Liquid Molding Systems, Inc., depicted in the various views of FIGS. 3a, b, and c. A preferred valve for use in the present invention should open at a pressure within the vessel of from about 14 psi (about atmospheric pressure) to about 40 psi (2070 mmHg).

Referring now to FIG. 2, the valve 3 may be seated into the opening 7 of the vessel 2 and fixed securely down onto the flange or lip 8 of the vessel 2 with a crimp or snap ring 9 or other suitable fastening ring. It is important that the valve properly seat into the opening of the vessel so that no gasses can escape around the periphery of the valve. In this way the pressure can be built up in the vessel to trigger the opening of the valve. FIG. 2 shows a perspective, multi-component view, and FIGS. 3a, 3b, and 3c show a perspective view, a top view, and a side view, respectively, of a preferred valve for use in the present invention, all views depicting the closed non-venting configuration of the valve. The fastening ring 9 shown in FIG. 2 may be any suitable metal or plastic fastening ring that can be fitted over the valve 3 and the flange 8 of the vessel, and then screwed, snapped, crimped, glued or welded down onto the vessel around the flange, in order to seal the valve against the opening of the vessel, with additional materials as necessary to assist in the sealing of the valve against the opening of the vessel, (adhesives, gaskets and the like). For example, the fastening ring 9 may be injection molded plastic (e.g. PP or PE), or it may be stamped or forged metal (tin, steel, aluminum or the like). Fastening ring 9 may be internally threaded with threads that match threads on the neck of the opening of the vessel. Flange 8 of the vessel may be a molded-in bevel or ridge, or may be a rolled lip, depending on the materials of construction for the vessel 2. The former is more preferred if the vessel is blow molded from plastic or cast from glass, whereas the latter is more preferred if the vessel is constructed from metal. Alternatively the circumferential edge around the opening of a metal vessel may be left bare, and then rolled together with the bottom edge of the fastening ring 9 (similar to rolling the valve cup and the top of an aerosol can together to seal an aerosol valve assembly down onto an aerosol can body). Regardless of the shape/size of the flange 8 around the opening of the vessel, the shape is preferably complimentary to the shape of the underside circumference of the valve such that the valve can sit on and fit well on this flange. FIG. 2 shows a perspective view of one embodiment of the vessel opening and valve of the present invention wherein an elastomeric valve 3 is fitted onto the beveled flange 8 of a vessel 2 with threaded opening, and wherein the valve is secured down with a threaded fastening ring 9. FIG. 3a shows a perspective view of a preferred elastomeric valve for use in the present invention, wherein the slits 31 form the pathway for the escaping vapors when the valve is in a pressurized situation. Likewise, FIGS. 3b and 3c show the same preferred valve from different views, and in these views the slits 31 are also visible.

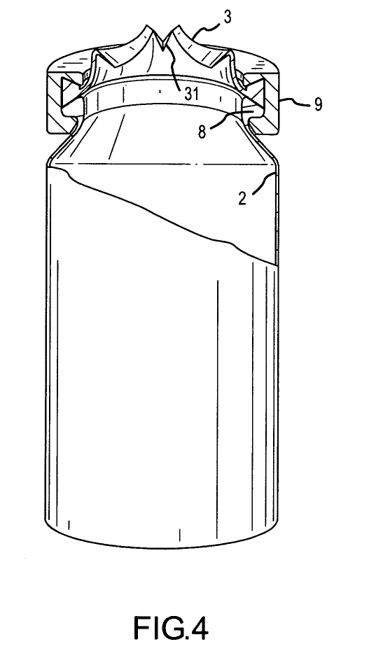

FIG. 4 shows a cross-sectional view of the top portion of a preferred embodiment of the vessel of the present invention. In this view, the valve 3 is shown secured down onto flange 8 by fastening ring 9, and is also shown in the inverted (inside-out) venting configuration and where the warm vapors are venting out of the vessel 2 through the open slits 31. As mentioned above, the preferred pressure-responsive valve for use in the present invention is an elastomeric valve that inverts and opens its slits outwards in response to internal pressure. Also shown in FIG. 4 are the walls of the vessel 2 culminating in the molded or rolled flange 8. The fastening ring 9 is shown holding the valve 3 down onto the flange 8 of the vessel such that the pressurized vapors can only escape the vessel through the valve slits and not leak out around the valve.

FIG. 5 shows a further elaboration of the vapor-dispersing device of the present invention wherein the device further comprises cooling means 6. Cooling means 6 may be powered and controlled from the electrical control means 5 that also controls the heating means. The means 6 may allow better and more precise control of the internal temperatures within the vessel 2, and therefore more precise control of the frequency and duration of the vapor burst from the device. For example, the electrical control means 5 may be programmed such that the heating means turns on for a fixed period of time, followed by a period of time when the cooling means 6 is then powered, (programming described below). In this way the electrical control means 5 may operate to alternate power between the heating means and the cooling means to a program set by the manufacturer and/or changeable by the user. The cooling means 6 may also help to push the vented warm vapors further out from the device into the surrounding environment depending on the position of the means in relationship to the opening of the vessel. Therefore, a preferred embodiment of the present invention is where the electrical control means supplies power to the heating means for a fixed time period, the vessel warms up and the internal pressure increases, opening the valve to burst some vapor. At that time, the control means switches power to the cooling means wherein the released vapors are then blown out into the surroundings and the vessel is cooled down simultaneously. This repeating heating/cooling cycle produces bursts of warmed vapors that are cast out into the surroundings. Cooling means 6 may be comprised of any combination of motors and fan blade assemblies, as is well known in the cooling fan industry. For example, the means may be comprised of an AC or DC motor wherein the axle of the motor may rotate a centrifugal impeller or squirrel cage, or drive a fan blade propeller or the like. The cooling means may also further comprise its own housing that is configured to direct the airflow from the fan blades in a particular direction. For example, a nautilus shaped fan housing may be used to channel the air coming out laterally and circumferentially from a squirrel cage into a single direction, as is commonly seen in centrifugal blowers. Another embodiment of the device of the present invention comprises thermostatically controlled heating and cooling of the vessel through the electrical control means electrically connected to both the heating means and the cooling means and to one or more temperature sensors.

The heating means, supported within the housing of the device conceptually shown in FIGS. 1, 5, and 6, may be comprised of at least one resistive heating element. For example, a ceramic resistor, or a series of resistors, may be used as the heat source in the heating means and these emanate heat when current is run through them, (e.g. PTC's—Positive Temperature Coefficient heating elements). The simplest configuration for the heating means is one or more PTC resistors in close proximity to or surrounding the vessel 2, that is, in heat-transfer relationship to the vessel when the vessel is inserted into the recess of the housing. Such resistive heating elements configured for use in a device to heat a vessel are described in U.S. patent application Publication US2003/0007887 (Roumpos, et al.), and U.S. Pat. No. 5,809,870 (Baillieul) and U.S. Pat. No. 6,413,476 (Barnhart), and incorporated herein by reference. For example, a PTC element may be positioned such that it contacts the bottom of the vessel when the vessel is inserted into the recess of the housing. More elaborate means may be preferred, for example the heating means may comprise a heating wires encased in a fabric shell that forms the overall shape of the recess for accommodating the vessel. The heating means may also consist of thin film heaters wherein the heater “trace”, painted onto a thin flexible plastic film, liberates heat when electrically powered. In this way the heating means can conform around the shape of the vessel. A preferred embodiment is to utilize a heating means that is supported within the housing of the present invention and which also conforms around the vessel when the vessel is inserted within the housing. It is preferred to have a heating means that is able to heat the contents of the vessel from between about ambient temperature to about 350° F.

The electrical control means 5 is shown conceptually in FIGS. 1, 5 and 6. It may consist of different configurations depending on the power source (AC or DC battery) and whether or not the means is intended to control a cooling means as well as the heating means, and if the overall circuitry further comprises thermostatic and logic control. Minimally the electrical control means 5 supplies power to the heating means. It may house at least one battery or it may conduct AC power from an electrical outlet through electrical receptacle prongs or from a cord with an electrical plug, to the heating means and optionally to the cooling means. For example, the control means 5 may comprise a voltage supply and a switch, with internal electrical connection to the heating means. In this way the electrical control means 5 may take AC house current (110 or 220 v) and route it directly into one or more PTC resistive heating elements within the heating means through a switch, wires and contacts. The main control switch may include a simple on/off switch, and/or the electrical control means may also include a multiple position switch for “High-Medium-Low” settings that provides for selection of three electrical current levels. The multiple positions switch may incorporate a rheostat to adjust the temperature of the vessel, or may control an integrated circuit to control the heating of the vessel by adjusting the frequency and duration of the heating. The control means 5 may be much more elaborate, comprising a timer circuit comprising an integrated circuit, and/or a thermostat, and/or a programmable integrated circuit. The electrical control means may further comprise a gas sensor for detecting malodors or marker molecules, or a light or a sound sensor, for turning on the power in the device when the device senses odors, marker molecules, light and/or sounds. The electrical control means may further include a digital display for logic control. The programmable IC may allow the user to operate the device at different intensity levels. The function of the integrated circuit is to control the voltage signals to the heating means and optionally to the cooling means. Incorporating a gas sensor, or light or sound sensor may allow the device to operate independently of user interaction, (i.e., entirely automatic). Other than incorporating a programmable integrated circuit for controlling voltage to the heating means, a simple thermostat may be incorporated next to the vessel and that thermostat may be used to regulate the heating/cooling cycles to keep the vessel within a prescribed temperature range. More sophisticated temperature sensors may be incorporated in the circuitry to aid in maintaining the temperature of the vessel.

FIG. 6 shows another embodiment of the present invention, wherein the vessel 2, the volatizable composition 10 within, valve 3, and fastening ring 9 all in total comprise a refill 20 for the device of the present invention. Most preferred is to market sealed vessels that the consumer may interchange in the device of the present invention, simply by placing the new refill 20 into the housing 4 of the present invention. The device of the present invention may include a pressure switch to sense when a vessel is in the device, and may also include other sensors such as end-of-use sensors (optical, magnetic float, etc.) that signal to the user that the vessel is empty and in need of replacement. The advantage of using sealed vessels as the refill for the vapor-dispersing device of the present invention is that the user does not need to touch the volatile composition within the vessel at any time. This is particularly important if the device is configured for use as an insecticide delivery device or if the device is used in medicine to vaporize medicaments that are packaged sterile and need to remain so. As an article of manufacture and a refill for use in the present invention, the assembled refill 20 shown in FIG. 6 may also include a merchandising cap snapped or screwed down over the top of the valve 3 and ring 9 (not shown), or snapped within the ring 9 to cover only the exposed valve 3, or the refill 20 may include a shrink wrapping or other sealing over only the exposed valve of the refill or over the entire top of the vessel, or over the entire vessel. For example, these seals or wraps may be metal foil, wax or plastic shrink-wrap. In this way the refill may be merchandized without fear of leakage or contamination of the contents, or fear that the valve will dry out or otherwise be breached.

As shown in FIG. 6, essential to the device of the present invention is a volatizable composition 10 contained within the vessel 2. As mentioned above, the volatizable composition may be in any number of possible physical forms, for example a thin liquid, a viscous liquid, a gel, a slurry, an emulsion, a suspension, a wax, a solid, granules, crystals, coated granules, saturated pads, and the like. It is important to point out that not all of the composition need be volatile. For example, volatile materials may be absorbed into porous carriers, (e.g. porous beads) and these treated carriers may comprise the volatizable composition held within the vessel. Not all of the composition need be evaporated during the operation of the device. After the volatiles are evaporated there may still be non-volatile chemicals or inert materials such as ceramic or plastic beads, cellulose fibers, pads, cotton wads, etc., left behind in the vessel.

Most preferred is to contain from about 1 gram to about 5 kg of volatizable composition in the pressurizable vessel. Depending on whether the composition is a fragrance, an insecticide or a medicine, the composition may contain anywhere from trace actives to 100% actives and may contain any number and amount of solvents and/or carriers, volatile or otherwise. For example, the device of the present invention may comprise a volatizable composition further consisting of only a single volatile chemical such as citronella. In another embodiment of the invention for medicinal use, the volatizable composition may comprise only eucalyptus oil. The composition may comprise anywhere from one or a few to up to many active materials dissolved or compounded with solvents and carriers that may or may not be volatile. Most preferred is to utilize volatile compositions (comprising mixtures of actives and solvents together) wherein all of the components are volatile and that contribute to the internal vapor pressure that develops upon heating of the composition. It should be pointed out that water may be a useful solvent in the volatizable composition of the present invention, to supply humidity along with vaporization of other volatile materials in the composition, or water may be the sole volatizable material within the vessel for when the device is used strictly as a humidifier.

For use as a fragrance vapor dispersing device, the fragrance components of the volatizable composition in the present invention may comprise one of more volatile organic compounds available from any of the now known, or hereafter established, perfumery suppliers, such as International Flavors and Fragrances (IFF) of New Jersey, Givaudan of New Jersey, Firmenich of New Jersey, etc. Many types of fragrances can be used in the present invention. Preferably the fragrance materials are volatile essential oils. The fragrances, however, may be synthetically derived materials (aldehydes, ketones, esters, etc.), naturally derived oils, or mixtures thereof. Naturally derived fragrance substances include, but are not limited to, musk, civet, ambergis, castoreum and like animal perfumes; abies oil, ajowan oil, almond oil, ambrette seed absolute, angelic root oil, anise oil, basil oil, bay oil, benzoin resinoid, bergamot oil, birch oil, bois de rose oil, broom abs., cajeput oil, cananga oil, capsicum oil, caraway oil, cardamon oil, carrot seed oil, cassia oil, cedar leaf, cedarwood oil, celery seed oil, cinnamon bark oil, citronella oil, clary sage oil, clove oil, cognac oil, coriander oil, cubeb oil, cumin oil, camphor oil, dill oil, estragon oil, eucalyptus oil, fennel sweet oil, galbanum res., garlic oil, geranium oil, ginger oil, grapefruit oil, hop oil, hyacinth abs., jasmin abs., juniper berry oil, labdanum res., lavander oil, laurel leaf oil, lavender oil, lemon oil, lemongrass oil, lime oil, lovage oil, mace oil, mandarin oil, mimosa abs., myrrh abs., mustard oil, narcissus abs., neroli bigarade oil, nutmeg oil, oakmoss abs., olibanum res., onion oil, opoponax res., orange oil, orange flower oil, origanum, orris concrete, pepper oil, peppermint oil, peru balsam, petitgrain oil, pine needle oil, rose abs., rose oil, rosemary oil, sandalwood oil, sage oil, spearmint oil, styrax oil, thyme oil, tolu balsam, tonka beans abs., tuberose abs., turpentine oil, vanilla beans abs., vetiver oil, violet leaf abs., ylang ylang oil and like vegetable oils, etc. Synthetic fragrance materials include but are not limited to pinene, limonene and like hydrocarbons; 3,3,5-trimethylcyclohexanol, linalool, geraniol, nerol, citronellol, menthol, bomeol, borneyl methoxy cyclohexanol, benzyl alcohol, anise alcohol, cinnamyl alcohol, β-phenyl ethyl alcohol, cis-3-hexenol, terpineol and like alcohols; anethole, musk xylol, isoeugenol, methyl eugenol and like phenols; α-amylcinnamic aldehyde, anisaldehyde, n-butyl aldehyde, cumin aldehyde, cyclamen aldehyde, decanal, isobutyl aldehyde, hexyl aldehyde, heptyl aldehyde, n-nonyl aldehyde, nonadienol, citral, citronellal, hydroxycitronellal, benzaldehyde, methyl nonyl acetaldehyde, cinnamic aldehyde, dodecanol, α-hyxylcinnamic aldehyde, undecenal, heliotropin, vanillin, ethyl vanillin and like aldehydes; methyl amyl ketone, methyl β-naphthyl ketone, methyl nonyl ketone, musk ketone, diacetyl, acetyl propionyl, acetyl butyryl, carvone, menthone, camphor, acetophenone, p-methyl acetophenone, ionone, methyl ionone and like ketones; amyl butyrolactone, diphenyl oxide, methyl phenyl glycidate, .gamma.-nonyl lactone, coumarin, cineole, ethyl methyl phenyl glicydate and like lactones or oxides; methyl formate, isopropyl formate, linalyl formate, ethyl acetate, octyl acetate, methyl acetate, benzyl acetate, cinnamyl acetate, butyl propionate, isoamyl acetate, isopropyl isobutyrate, geranyl isovalerate, allyl capronate, butyl heptylate, octyl caprylate octyl, methyl heptynecarboxylate, methine octynecarboxylate, isoacyl caprylate, methyl laurate, ethyl myristate, methyl myristate, ethyl benzoate, benzyl benzoate, methylcarbinylphenyl acetate, isobutyl phenylacetate, methyl cinnamate, cinnamyl cinnamate, methyl salicylate, ethyl anisate, methyl anthranilate, ethyl pyruvate, ethyl α-butyl butylate, benzyl propionate, butyl acetate, butyl butyrate, p-tert-butylcyclohexyl acetate, cedryl acetate, citronellyl acetate, citronellyl formate, p-cresyl acetate, ethyl butyrate, ethyl caproate, ethyl cinnamate, ethyl phenylacetate, ethylene brassylate, geranyl acetate, geranyl formate, isoamyl salicylate, isoamyl isovalerate, isobornyl acetate, linalyl acetate, methyl anthranilate, methyl dihydrojasmonate, nopyl acetate, β-phenylethyl acetate, trichloromethylphenyl carbinyl acetate, terpinyl acetate, vetiveryl acetate and like esters, and the like. Suitable fragrance mixtures may produce a number of overall fragrance type perceptions including but not limited to, fruity, musk, floral, herbaceous (including mint), and woody, or perceptions that are in-between (fruity-floral for example). Typically these fragrance mixtures are compounded by mixing a variety of these active fragrance materials along with various solvents to adjust cost, evaporation rates, hedonics and intensity of perception. Well known in the fragrance industry is to dilute essential fragrance oil blends (natural and/or synthetic) with solvents such as ethanol, isopropanol, hydrocarbons, acetone, glycols, glycol ethers, water, and combinations thereof, and using solvent up to as much as 90% of the volatizable fragrance composition. Thus a preferred fragrance composition for use as the volatizable composition in the present invention is comprised of a mixture of many fragrance actives and volatile solvents, sometimes along with smaller amounts of emulsifiers, stabilizers, wetting agents and preservatives. More often than not, the compositions of the fragrance mixtures purchasable from the various fragrance supply houses remain proprietary.

Volatizable insecticide compositions for use in the present invention are those of the type described in U.S. Pat. No. 4,663,315 (to Hasegawa, et al.) and incorporated herein by reference. Hasegawa describes many useful volatizable insecticidal, disinfectant, fungicidal, rodenticidal and animal deterrent compositions that will work well within the pressurizable vessel of the present invention.

Medicament compositions for use as the volatizable composition in the present invention may be comprised of a single component (such as eucalyptus oil, menthol, camphor and the like) or may be a complex blend of medicinal actives and carriers (such as found in Vick's® Vapor-Rub), and therefore may be in the form of a thin or thick liquid, a paste, a wax or a solid, or even as natural leaves. In one embodiment of the present invention, medicaments normally used in warm-steam vaporizer cups (such as Vick's®), may be placed directly into the pressurizable vessel. A most unusual embodiment of the present invention is to place medicinal leaves (mint, eucalyptus, lavender and the like) or even a potpourri blend of materials (sticks, fruits, leaves, berries, etc.) directly into the pressurizable vessel. Most preferred is to use these visually appealing volatizable materials in a glass vessel so that they can be seen. There is no limit to the variety of materials that may be used as the volatizable composition and placed and sealed within the pressurizable vessel of the present invention.

As mentioned previously, it is preferable to use between 1 g and 5 kg of any of the above suggested volatizable fragrance, insecticide, animal deterrent, medicament, or potpourri compositions as the volatizable composition for use in the present invention and to seal the composition within the pressurizable vessel. Any of the above compositions that are liquids may be thickened into gels or pastes and then incorporated in the vessels as the volatizable composition. Or the liquid compositions may be absorbed into carriers (wax, pulp, cotton, cellulose pads, ceramics, wood, porous plastic, resins and the like), and these saturated carriers may be used as the volatizable compositions of the present invention. In these embodiments, the inert and non-volatile carrier will be left behind in the vessel once the volatiles are expended from the vessel. In one embodiment of the present invention, beads or ball bearings or the like may be embedded into a gel or thickened volatizable composition, which then become loosened within the vessel once the volatile materials are expended from the vessel. Their ability to “rattle” in the vessel can be used as a signal to the consumer that the vessel is empty of volatiles and should be replaced.

We have thus described a unique and new invention that comprises a pressurizable vessel further comprising a pressure-responsive valve and containing a volatizable composition that provides bursts of warm vapor to the surrounding environment upon controlled heating of the vessel and operation of the valve under pressure spikes. The device of the present invention will find use as an air freshener, an insecticide dispenser, a medicament vapor dispenser and as a humidifier.

We claim:

1. A vapor-dispersing device comprising:
a. a housing defining a recess,
b. a heating means supported in said housing,
c. a pressurizable vessel having at least one opening, said vessel being reversibly insertable into and removable from said recess and in heat-transfer relationship with said heating means when inserted into said recess,
d. a pressure-responsive valve in said opening of said vessel,
e. a volatizable composition contained within said vessel, and,
f. an electrical control means for regulating said heating means.

2. The vapor-dispersing device of claim 1, wherein said pressure-responsive valve is a one-piece polymeric valve further comprising slits that open in response to pressure.

3. The vapor-dispersing device of claim 2, wherein said valve is an elastomeric valve.

4. The vapor-dispersing device of claim 1, further comprising a fastening ring that secures said valve into said opening of said vessel.

5. The vapor-dispersing device of claim 4, wherein said fastening ring is made from plastic or metal.

6. The vapor-dispersing device of claim 5, wherein said fastening ring is internally threaded.

7. The vapor-dispersing device of claim 1 further comprising a cooling means.

8. The vapor-dispersing device of claim 7, wherein said cooling means comprises a motor and fan assembly.

9. The vapor-dispersing device of claim 7, wherein said cooling means and said heating means are both regulated by said electrical control means.

10. The vapor-dispersing device of claim 1, 7, 8 or 9, wherein said electrical control means further comprises a thermostat.

11. The vapor dispersing device of claim 1, wherein said electrical control means further comprises an electrical supply selected from the group consisting of 110 volts AC, 220 volts AC, 1.5 volts DC, 3 volts DC, 4.5 volts DC, 6 volts DC, 7.5 volts DC, 9 volts DC, 10.5 volts DC, 12 volts DC and 24 volts DC.

12. The vapor dispersing device of claim 11, wherein said electrical control means comprises at least one battery.

13. The vapor dispersing device of claim 1, wherein said electrical control means comprises an on/off switch.

14. The vapor dispersing device of claim 1, wherein said control means comprises a timer circuit programmable by the user.

15. The vapor-dispersing device of claim 4, further comprising a removable cap that encases said fastening ring, said valve and said opening of said vessel.

16. The vapor-dispersing device of claim 4, further comprising a shrink-wrap plastic or foil seal over said fastening ring, said valve and said opening of said vessel.

17. The vapor-dispersing device of claim 4, further comprising a shrink-wrap plastic film over entire periphery of said vessel.

18. The vapor-dispersing device of claim 1, wherein said volatizable composition is comprised of at least one volatile fragrance material.

19. The vapor-dispersing device of claim 1, wherein said volatizable composition is water.

20. The vapor-dispersing device of claim 1, wherein said volatizable composition is comprised of at least one insecticidal material.

21. The vapor-dispersing device of claim 1, wherein said volatizable composition is comprised of at least one rodenticidal material.

22. The vapor-dispersing device of claim 1, wherein said volatizable composition is comprised of at least one animal deterrent material.

23. The vapor-dispersing device of claim 1, wherein said volatizable composition is comprise of at least one medicament.

24. The vapor-dispersing device of claim 1, wherein said volatizable composition is selected from the group consisting of leaves, berries, fruit, sticks and nuts.

25. The vapor-dispersing device of claim 23, wherein said medicament is chosen from the group consisting of, eucalyptus, menthol, camphor, methyl salicylate, and lavender.

26. The vapor-dispersing device of claim 1, wherein said housing further comprises a lid that fastens over said vessel and secures said vessel in said recess.

27. The vapor-dispersing device of claim 1, wherein said vapor-dispersing device further comprises a weight-activated switch within said recess to detect the presence of said vessel within said recess.

28. The vapor-dispersing device of claim 1, wherein said electrical control means further comprises an odor-responsive gas sensor.

29. The vapor-dispersing device of claim 1, wherein said electrical control means further comprises a light-responsive sensor.

30. The vapor-dispersing device of claim 1, wherein said electrical control means further comprises a sound detector.

31. An article of manufacture merchandisable as a refill for a vapor-dispersing device, said article of manufacture comprising:
a. a pressurizable vessel having at least one opening;
b. a pressure-responsive valve seated in said opening of said vessel;
c. a fastening ring over said valve securing said valve into said opening;
d. a volatizable composition including at least one volatile component sealed within said vessel; and,
e. a removable cap snapped or screwed down over said ring and valve that covers said valve.

32. The article of manufacture of claim 31, wherein said pressurizable vessel is constructed of aluminum and said pressure-responsive valve is an elastomeric valve.

33. A method for dispensing vapor into the environment comprising the steps of:
a. providing an article of manufacture according to claim 31,
b. removing said removable cap by unsnapping or unscrewing to expose said pressure-responsive valve,
c. inserting said article of manufacture into a device comprising a housing with a recess and heating means, said heating means supported by said housing in heat-transfer relationship to said article of manufacture, said heating means controlled by an electrical control means, and;
d. operating said device through interaction with said electrical control means.

34. The method of claim 33, wherein said pressure-responsive valve is configured to open and vent under internal pressure developed within said vessel when said vessel is heated.

35. The method of claim 34, wherein said valve periodically opens and vents internal pressure from said vessel in accordance with heating cycles delivered to said vessel from said heating means electrically controlled by said electrical control means.

36. A method of controlling the dispensing of a volatizable composition as a warmed vapor from a pressurizable vessel comprising the steps of:
a. providing a volatizable composition sealed within a pressurizable vessel having an opening fitted with a pressure responsive valve,
b. inserting said pressurizable vessel within the recess of a housing that supports a heating means in heat-transfer relationship to the inserted vessel, and,
c. controlling the heating of said vessel by said heating means such that the internal pressure of the vessel rises into the range of pressure at which said pressure responsive valve opens to vent said internal pressure.

37. The method of claim 36, wherein said heating of said vessel is regulated through electrical control of said heating means by an electrical control means that supplies power to said heating means and that is turned on and regulated by the user.
